(19) United States
(12) Patent Application Publication
(10) Pub. No.: US 2026/0184186 A1
(43) Pub. Date: Jul. 2, 2026

(54) DC CONVERTER ARRANGEMENT, ELECTRIC VEHICLE, AND METHOD FOR OPERATING A DC CONVERTER ARRANGEMENT

(71) Applicant: Robert Bosch GmbH, Stuttgart (DE)

(72) Inventors: Julian Veitengruber, Leinfelden-Echterdingen (DE); Tine Konjedic, Boeblingen (DE)

(21) Appl. No.: 19/113,182

(22) PCT Filed: Jun. 30, 2023
(86) PCT No.: PCT/EP2023/067989

§ 371 Date: Mar. 19, 2025

(30) Foreign Application Priority Data
Sep. 27, 2022 (DE) 10 2022 210 178.2

(51) Int. Cl. B60L 15/00; H02J 1/082

(52) U.S. Cl. CPC B60L 15/007; H02J 1/082

(57) ABSTRACT

The invention discloses a DC voltage converter arrangement for supplying power to a low-voltage network from a high-voltage network in an electric vehicle. In addition to a DC voltage converter, the DC voltage converter arrangement comprises a supplementary auxiliary power supply. This auxiliary power supply can provide electrical power to the control components of the DC voltage converter. On the other hand, the power supply can also feed electrical energy into the low-voltage network, so that the DC voltage converter can be deactivated when there is low power demand in the low-voltage network.

### BACKGROUND

The present invention relates to a DC voltage converter arrangement, in particular a DC voltage converter arrangement for transmitting electrical energy from a high-voltage network to a low-voltage network. The present invention further relates to an electric vehicle having such a DC converter arrangement as well as to a method for operating a DC converter arrangement.

Fully or at least semi-electrically driven vehicles typically have two electrical on-board power systems. A high-voltage network has an electrical voltage of a few hundred volts, for example 400 or 800 volts. In this high-voltage network, there is usually an electrical energy store, such as a traction battery. This high-voltage network preferably supplies power to electrical consumers with high power demands, such as the vehicle's electric drive system and, if applicable, climate control units or similar. Additionally, electrical consumers with lower power consumption, such as control units, sensors, actuators, comfort functions, or multimedia applications, can be supplied with electrical energy via a low-voltage network. This low-voltage network can have an electrical voltage in the range of 12 volts, for example.

Publication DE 10 2013 225 097 describes an energy management method for operating an electrical on-board network of a motor vehicle with a high-voltage network and a low-voltage network, wherein in a sleeping state, a consumer in the low-voltage network is supplied with electrical power from the high-voltage network.

### SUMMARY

The present invention discloses a DC voltage converter arrangement, an electric vehicle, and a method for operating a DC voltage converter arrangement having the features of the independent claims. Further advantageous embodiments are the subject-matter of the dependent claims.

The following is provided accordingly:

A DC voltage converter arrangement having a DC voltage converter and an auxiliary power supply. The DC voltage converter is configured so as to be coupled to a high-voltage network at a first terminal. The DC voltage converter is configured so as to be coupled to a low-voltage network at a second terminal. The auxiliary power supply is configured so as to be coupled to the high-voltage network at an input terminal. Furthermore, the auxiliary power supply is configured so as to be coupled to the low-voltage network at an output terminal. Additionally, at a control circuit of the DC voltage converter, the auxiliary voltage is configured so as to provide a supply voltage for the control circuit.

The following is furthermore provided:

An electric vehicle having a high-voltage network, a low-voltage network, and a DC voltage converter according to the invention.

The following is furthermore provided: A method for operating a DC converter arrangement as well as to a method for operating a DC converter arrangement. The method comprises a step of monitoring the output of electrical power from the DC voltage converter arrangement to the low-voltage network. Furthermore, the method comprises a step of deactivating the DC voltage converter if the electrical power from the DC voltage converter arrangement to the low-voltage network falls below a predetermined first threshold. Additionally, the method comprises a step of activating the DC voltage converter if the electrical power from the DC voltage converter arrangement to the low-voltage network exceeds a predetermined second threshold value. The first threshold and second threshold can be set to the same value. Alternatively, a hysteresis between the first threshold value and the second threshold value can also be provided.

Electric vehicles typically have a high-voltage network and a low-voltage network coupled to each other via a DC voltage converter arrangement. For example, if such a vehicle is in a sleep or parking mode, some consumers in the low-voltage network will continue to be active. In conventional systems, these consumers can be supplied with electrical power, for example, via a battery in the low-voltage network. This battery typically has a high weight, requires space, and incurs costs. However, if this battery is to be omitted, the required power for the low-voltage network must also be supplied from the high-voltage network via the DC converter arrangement when the vehicle is switched off. However, the DC voltage converter commonly used in the DC voltage converter arrangement has rather low efficiency when supplying the low power output of a parked vehicle. As a result, the electrical losses increase in the vehicle's sleeping state.

It is therefore an idea of the present invention to provide auxiliary voltage tracking in a DC voltage converter arrangement for coupling the high-voltage network with the low-voltage network. On the one hand, this auxiliary power supply can provide power to control components in a DC voltage converter of the DC voltage converter arrangement. In addition, the auxiliary power supply can also provide the required electrical power for the low-voltage network even when there is a low power demand in the low-voltage network.

In this way, when there is low power demand in the low-voltage network, the DC voltage converter in the DC voltage converter arrangement can be deactivated. Because such an arrangement can always provide efficient energy transmission from the high-voltage network to the low-voltage network, a supplementary energy store, such as a battery, can be omitted in the low-voltage network of the electric vehicle. Thus, a parked vehicle can also provide a continuous and efficient power supply to the consumers in the low-voltage network. Due to the increased efficiency of the energy transfer, especially at low power consumption in the low-voltage network, the energy drawn from the traction battery in the high-voltage network can also be reduced when vehicles are parked. Thus, the risk of the traction battery depleting too quickly in parked vehicles decreases.

The high-voltage network and the low-voltage network can each be DC voltage networks that have an electrical voltage at a predetermined voltage level. In principle, it is also possible for the high-voltage network and/or the low-voltage network to comprise a plurality of separate sub-networks. These individual sub-networks can be completely separated from one another. If necessary, the individual sub-networks of the high-voltage network or the low-voltage network can be electrically coupled to each other using suitable switching or separating elements.

According to one embodiment, the auxiliary power supply is configured so as to provide, using an electrical voltage from the high-voltage network, a low voltage that is galvanically isolated from the high-voltage network at the control circuit of the DC voltage converter and in the low-voltage network. By galvanically separating the high-voltage network from the low-voltage side of the auxiliary power supply, a secure power supply to the low-voltage consumers is possible. The galvanic isolation can be carried out, for example, by means of a transformer, or the like.

According to one embodiment, the auxiliary power supply is configured so as to set a specified target voltage in the low-voltage network. The target voltage can also be dynamically adjusted, if necessary. This allows the new voltage in the low-voltage network to be achieved as quickly as possible in the event of a sudden target voltage change. In this way, the voltage level in the low-voltage network can be stabilized by means of the auxiliary power supply. In particular, the auxiliary power supply can regulate the target voltage in the low-voltage network within predetermined power limits. In other words, the maximum power or the maximum output current of the auxiliary power supply is limited to a specified maximum value.

According to one embodiment, the auxiliary power supply is configured so as to provide, using an electrical voltage from the low-voltage network, a high voltage for the high-voltage network that is galvanically isolated from the low-voltage network. In particular, the auxiliary power supply can provide bidirectional power transmission between the high-voltage network and the low-voltage network.

According to one embodiment, the control device comprises a DC voltage converter. The control device can be configured so as to activate the DC voltage converter if an electrical power from the auxiliary power supply to the low-voltage network exceeds a predetermined threshold value. In this way, as power demand in the low-voltage network increases, the DC voltage converter can take over the power supply of the low-voltage network. Thus, a secure power supply in the low-voltage network is ensured, even if the power demand exceeds the maximum permissible power output of the auxiliary power supply. Thus, the auxiliary power supply can be optimized for a low maximum power output, which is typically sufficient for the power demand of a stationary vehicle as well as the power demand for starting the DC voltage converter from the sleep mode.

According to one embodiment, the DC voltage converter arrangement comprises a switching device. The switching device can be configured so as to open or close an electrical connection between the auxiliary power supply and the low-voltage network. In this way, the output of the auxiliary power supply can be electrically coupled to the low-voltage network only as needed. According to one embodiment, the switching device of the DC voltage converter arrangement is configured so as to open the electrical connection between the auxiliary power supply and the low-voltage network if the DC voltage converter is active. Thus, the output of the auxiliary power supply can be decoupled from the low-voltage network when the power supply of the low-voltage network is provided via the DC voltage converter of the DC voltage converter arrangement. In this way, for example, the auxiliary power supply can be protected against interference from the low-voltage network.

According to one embodiment, the DC voltage converter arrangement comprises a first buffer element. This first buffer element can be electrically coupled to the low-voltage network. In particular, the first buffer element can be configured so as to compensate for voltage fluctuations in the low-voltage network. For example, the first buffer element can be a capacitor or a battery with a very low storage capacity.

According to one embodiment, the DC voltage converter arrangement comprises a second buffer element. The second buffer element can be configured so as to be electrically coupled to the control circuit and to compensate for voltage fluctuations in the supply voltage of the control circuit. In this way, voltage fluctuations in the control circuit can be balanced, thus ensuring a stable supply voltage. The second buffer element can also be, for example, a capacitor or a battery with a very low storage capacity.

According to one embodiment of the electric vehicle, the DC voltage converter arrangement is configured so as to deactivate the DC voltage converter when the vehicle is in parking mode. In particular, the DC voltage converter can be deactivated if power consumption by consumers in the low-voltage network during sleeping or parking operation falls below a specified threshold value. In such a case, typically only a few consumers, such as control components for keyless vehicle access, are active. Therefore, the power demand in the low-voltage network in this state can be covered by the auxiliary power supply alone.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic illustration of a block diagram of a power supply system for an electric vehicle having a DC converter arrangement according to one embodiment;

FIG. 2: a schematic illustration of a block diagram of a DC voltage converter arrangement according to one embodiment; and

FIG. 3: a flowchart underlying a method for operating a DC voltage converter arrangement according to one embodiment.

### DETAILED DESCRIPTION

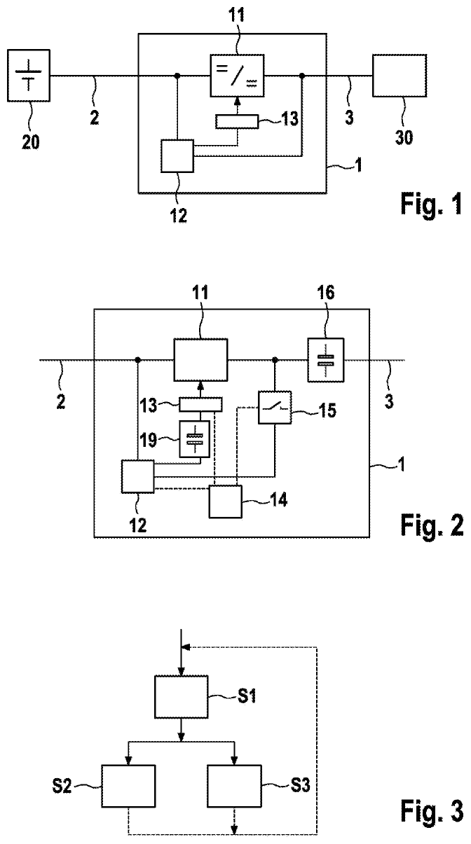

FIG. 1 shows a schematic illustration of an electrical power supply, which can be the basis for an electric vehicle, for example. For example, such an electric vehicle can be equipped with a high-voltage network 2 and a low-voltage network 3. For example, the high-voltage network 2 can be powered by an electrical energy store, such as a traction battery 20. For example, high-power consumers such as an electrical drive system, an air conditioning unit, or other optional electrical consumers can be powered via this high-voltage network 2. The low-voltage network 3 can comprise a plurality of electrical consumers 30 with lower power consumption. For example, these consumers 30 can include control units, sensors, actuators, auxiliary drives, comfort functions, multimedia components, or similar. Furthermore, components for keyless access, such as communication devices for communicating with remote devices such as smartphones or similar, can also be provided in this low-voltage network 2. This allows some functions, such as pre-heating or cooling the vehicle, to be remotely controlled via such wireless connections.

The high-voltage network 2 can be electrically coupled to the low-voltage network 3 via a DC voltage converter 1. In this way, the consumers 30 in the low-voltage network 3 can be supplied with electrical energy from the high-voltage network 2. In the embodiment shown here, an electrical energy store such as a lead-acid battery or similar can be expressly omitted from the low-voltage network 3.

The DC voltage converter arrangement 1 comprises a DC voltage converter 11. This DC voltage converter 11 can convert electrical energy from the high-voltage network 2 into an electrical voltage that corresponds to the electrical voltage in the low-voltage network 3. The DC voltage converter 11 is typically configured for electrical power outputs that can also cover the power demand in the low-voltage network 3 at full load. If necessary, the DC voltage converter 11 can include a parallel connection of a plurality of DC voltage converter units.

The DC voltage converter 11 can be controlled via a control circuit 13. The control circuit 13 can take into account the target and actual values at the DC voltage converter arrangement 1 for control purposes. In particular, semiconductor switching elements in the DC voltage converter 11 can be driven via corresponding driver circuits in the control circuit 13.

Furthermore, an auxiliary power supply 12 is provided in the DC voltage converter arrangement 1. An input of this auxiliary power supply 12 is electrically coupled to the high-voltage network 2 so that the auxiliary power supply 12 can continuously draw its electrical energy from this high-voltage network 2. This auxiliary power supply 12 can specifically supply electrical power to the control circuit 13. The output voltages provided by the auxiliary power supply 12 are galvanically isolated from the high-voltage network 2. For this purpose, a transformer or similar for galvanic isolation can be provided in the auxiliary power supply 12.

Moreover, the auxiliary power supply 12 can also provide electrical power to the low-voltage network 3. However, the maximum power output of the auxiliary power supply 12 is limited and significantly less than the maximum power output of the DC voltage converter 11.

The maximum possible power output of the auxiliary power supply 12 can have dimensions such that the electrical power provided by the auxiliary power supply 12 is sufficient to cover the power demand of the electrical consumers 30 in the low-voltage network 3 when the vehicle is parked or sleeping. In such a case, because only a few components are typically active in the low-voltage network 3, for example a receiver for a key fob, components for communication with remote devices, or sensors for an alarm system, the auxiliary power supply 12 can be configured for a relatively low maximum power output while maintaining high efficiency. Thus, the sleeping current demand of such a vehicle can be reduced.

As long as the power demand for the consumers 30 in the low-voltage network 3, in particular in a sleeping vehicle, can be met by the auxiliary power supply 12, the DC voltage converter 11 can be deactivated. In other words, the power supply for the low-voltage network 3 is provided entirely by the auxiliary power supply 12.

If the power demand in the low-voltage network 3 exceeds a specified threshold value, the DC voltage converter 11 can be activated in order to meet the increased power demand in the low-voltage network 3. Because the auxiliary power supply 12 also provides electrical power to the control circuit 13 for the DC voltage converter 11, such activation is possible at any time.

Furthermore, it is also possible for the auxiliary power supply 12 to transfer electrical energy from the high-voltage network 2 to the low-voltage network 3 (or, if necessary, in the opposite direction) parallel to, i.e. simultaneously with, the DC voltage converter 11. In this way, the energy transfer can be regulated, if necessary, so that the DC voltage converter 11 and/or the auxiliary power supply 12 can operate at the most efficient working point possible. In this mode of operation, the auxiliary power supply 12 can in particular support the energy transmission between the high-voltage network 2 and the low-voltage network 3 even during driving operation of an electric vehicle.

The DC voltage converter 11 and/or the auxiliary power supply 12 can, if necessary, also be configured for bidirectional energy transmission between the high-voltage network 2 and the low-voltage network 3. The power flow through the auxiliary power supply 12 can also be limited to a maximum power or a maximum output current. In this way, electrical energy from the low-voltage network 3 can also be transmitted toward the high-voltage network 2, if necessary. For example, the energy transmission or power flow between the high-voltage network 2 and the low-voltage network 3 can be controlled so that an electrical voltage in the low-voltage network 3 is stabilized at a specified target value. If necessary, the control system can also dynamically adjust the electric voltage in the low-voltage network within a specified voltage range between a minimum and maximum target value.

FIG. 2 shows a schematic illustration of a block diagram of a DC voltage converter arrangement 1 according to one embodiment. This can in particular refer to the DC converter arrangement 1 according to FIG. 1, which has already been described above.

As shown in FIG. 2, the auxiliary power supply 12 can comprise a control device 14. The arrangement shown here as a separate control device 14 and/or its functionality can, if necessary, also be integrated into the previously described control circuit 12. The control device 14 can control the components of the DC voltage converter arrangement 1 and in particular activate or deactivate the DC voltage converter 11. In addition, the further components of the DC voltage converter arrangement 1 still to be described below can also be controlled by the control device 14. For example, the control device 14 can determine the power demand for the low-voltage network 3. For this purpose, for example, the control device 14 can evaluate measured values from current sensors (not shown) in order to determine the electrical current from the DC voltage converter arrangement 1 into the low-voltage network 3 and thus the corresponding power. Moreover, the control device 14 can also receive further data or signals. For example, the control device 14 can receive information concerning an operating state of the vehicle. Accordingly, the control device 14 can activate the DC voltage converter 11 of the DC voltage converter arrangement 1 only when the vehicle is in a specified operating state, for example in a parking or sleeping mode. Furthermore, the control device 14 can activate the DC voltage converter 11 if there is an increased power demand in the low-voltage network 3 or if this is to be expected based on received data.

Furthermore, a limit for current, voltage, and/or power can be provided for the auxiliary power supply 12. In this way, it can be ensured that the auxiliary power supply 12 is neither overloaded and, if applicable, components in the connected high and low-voltage network 2, 3 are not damaged. In addition, the auxiliary power supply 12 can be started independently if a low-voltage power is lacking or fallen below in the low-voltage network 3.

The control of the auxiliary power supply 12 can be performed either digitally, for example from a central common control unit 13 for the DC voltage converter 11 or a separate control device 14, or in an analog manner.

Furthermore, a switching element 15 can be provided in the DC voltage converter arrangement 1, for example between the auxiliary power supply 12 and the low-voltage network 3. This switching element 15 can be closed in order to establish an electrical connection between the auxiliary power supply 12 and the low-voltage network 3. In this state, the auxiliary power supply 12 can feed electrical energy into the low-voltage network 3. By opening this switching element 15, the electrical connection between the auxiliary power supply 12 and the low-voltage network 3 can be interrupted. The switching element 15 can be opened, for example, when the power supply of the low-voltage network 3 is provided via the DC voltage converter 11. In this state, influences from the low-voltage network 3 on the auxiliary power supply 12 can be avoided, if necessary. The switching state of the switching element 15 can be controlled, for example, via the control device 14.

Moreover, at the position of reference number 15, i.e. between the auxiliary power supply 12 and the connection of the DC voltage converter arrangement 11 to the low-voltage network 3, other components can also be provided, such as filter assemblies, which eliminate or at least partially suppress the frequency of the signals as well as interference pulses.

Furthermore, a buffer element 16 can be provided in the DC voltage converter arrangement 1, for example. This buffer element can be electrically coupled to the low-voltage network 3. These buffer elements 16 can be, for example, a capacitor or a small battery with a low capacity. Such a buffer element 16 can compensate for voltage fluctuations in the low-voltage network 3. Such voltage fluctuations can occur, for example, during a short-term higher power demand in the low-voltage network 3 or during a change in power supply between the auxiliary power supply 12 and the DC voltage converter 11.

Additionally or alternatively, a further buffer element 19 can be provided, which stabilizes the supply voltage for the control circuit 13. This further buffer element 19 can also be, for example, a capacitor or a small battery with a low capacity.

FIG. 3 shows a flowchart underlying a method for operating a DC voltage converter arrangement 1 according to one embodiment. The DC voltage converter arrangement 1 can be the DC voltage converter arrangement 1 described above according to FIG. 1 or 2. Accordingly, the statements already made above also apply to the method as described below. Furthermore, the DC voltage converter arrangement 1 described above can also comprise any components required in order to implement the method described below.

In step S1, the electrical power output from the DC voltage converter arrangement 1 into the low-voltage network 3 is monitored.

In step S2, the DC voltage converter 11 of the DC voltage converter arrangement 1 is deactivated if the electrical power from the DC voltage converter arrangement 1 into the low-voltage network 3 falls below a predetermined first threshold. In particular, the DC voltage converter 11 can only be activated when an electric vehicle with the DC voltage converter arrangement 1 is in a predetermined operating state, for example, in a sleeping or parking mode or similar.

In step S3, the DC voltage converter 11 can be activated if electrical power from the DC voltage converter arrangement 1 into the low-voltage network 3 or the power demand in the low-voltage network 3 exceeds a predetermined second threshold value. Furthermore, the DC voltage converter 11 can also be activated when the operating state of the vehicle changes. For example, the DC voltage converter 11 can be activated when the sleeping state of the vehicle ends.

If applicable, the specified first threshold value and the predetermined second threshold value can be set to the same value. Alternatively, a hysteresis between the predetermined first threshold value and the predetermined second threshold value is also possible.

In summary, the present invention relates to a DC voltage converter arrangement for supplying power to a low-voltage network from a high-voltage network in an electric vehicle. In addition to a DC voltage converter, the DC voltage converter arrangement comprises a supplementary auxiliary power supply. This auxiliary power supply can provide electrical power to the control components of the DC voltage converter. On the other hand, the power supply can also feed electrical energy into the low-voltage network, so that the DC voltage converter can be deactivated when there is low power demand in the low-voltage network.

1. A DC converter arrangement (1) comprising:
a DC voltage converter (11) configured to be coupled to a high-voltage network (2) at a first terminal and coupled to a low-voltage network (3) at a second terminal, and
an auxiliary power supply (12) configured to be coupled to the high-voltage network (2) at an input terminal, to be coupled to the low-voltage network (3) at an output terminal, and, at a control circuit (13) of the DC voltage converter (11), to provide a supply voltage for the control circuit (13).

2. The DC voltage converter arrangement (1) according to claim 1, wherein the auxiliary power supply (12) is configured to provide, using an electrical voltage from the high-voltage network (2), a low voltage that is galvanically isolated from the high-voltage network (2) at the control circuit (13) of the DC voltage converter (11) and in the low-voltage network (3).

3. The DC voltage converter arrangement (1) according to claim 2, wherein the auxiliary power supply (12) is configured to set a specified target voltage in the low-voltage network (3) within predetermined power limits.

4. The DC voltage converter arrangement (1) according to claim 1, wherein the auxiliary power supply (12) is configured to provide, using an electrical voltage from the low-voltage network (3), a high voltage for the high-voltage network (2) that is galvanically isolated from the low-voltage network (3).

5. The DC voltage converter arrangement (1) according to claim 1, having a control device (14) configured so as to activate the DC voltage converter (11) if an electrical power that is emitted from the auxiliary power supply (12) into the low-voltage network (3) exceeds a predetermined threshold.

6. The DC voltage converter arrangement (1) according to claim 1, having a switching device (15) configured to open or close an electrical connection between the auxiliary power supply (12) and the low-voltage network (3).

7. The DC voltage converter arrangement (1) according to claim 6, wherein the switching device (15) is configured to open the electrical connection between the auxiliary power supply (12) and the low-voltage network (3) if the DC voltage converter (11) is active.

8. The DC voltage converter arrangement (1) according to claim 1, having a first buffer element (16) configured to be electrically coupled to the low-voltage network (3) and to compensate for voltage fluctuations in the low-voltage network.

9. The DC voltage converter arrangement (1) according to claim 1, having a second buffer element (19) configured to be electrically coupled to the control circuit (13) and to compensate for voltage fluctuations in the supply voltage of the control circuit (13).

10. An electric vehicle, having:
a high-voltage network (2),
a low-voltage network (3), and
a DC converter arrangement (1) according to claim 1.

11. The electric vehicle according to claim 10, wherein the DC voltage converter arrangement (1) is configured to deactivate the DC voltage converter (11) in a sleep mode of the electric vehicle if a power consumption of consumers (30) in the low-voltage network (3) falls below a specified threshold value.

12. A method for operating a DC voltage converter arrangement (1) according to claim 1, comprising the steps of:
monitoring (S1) an output of electrical power from the DC voltage converter arrangement (1) into the low-voltage network (3);
deactivating (S2) the DC voltage converter (11) if the electrical power from the DC voltage converter arrangement (1) into the low-voltage network (3) falls below a predetermined first threshold;
activating (S3) the DC voltage converter if the electrical power from the DC voltage converter arrangement (1) into the low-voltage network (3) exceeds a predetermined second threshold value.

13. The method according to claim 12, wherein the DC voltage converter (11) is deactivated only if the electric vehicle having the DC voltage converter arrangement (1) is in a predetermined operating mode.
